(19) United States
(12) Patent Application Publication
(10) Pub. No.: US 2012/0174219 A1
(43) Pub. Date: Jul. 5, 2012

(54) IDENTIFYING MOBILE DEVICE REPUTATIONS

(75) Inventors: Alejandro Manuel Hernandez, Cartersville, GA (US); Paul Judge, Atlanta, GA (US); Sven Krasser, Atlanta, GA (US); Phyllis Adele Schneck, Atlanta, GA (US); Jonathan Alexander Zdziarski, Bedford, NH (US)

(73) Assignee: MCAFEE, INC., Santa Clara, CA (US)

(21) Appl. No.: 13/108,671

(22) Filed: May 16, 2011

Related U.S. Application Data
(60) Provisional application No. 61/334,799, filed on May 14, 2010.

(51) Int. Cl. G06F 21/00

(52) U.S. Cl. 726/22

(57) ABSTRACT

Methods and systems for operation upon one or more data processors for assigning a reputation to a messaging entity by analyzing the attributes of the entity, correlating the attributes with known attributes to define relationships between entities sharing attributes, and attributing a portion of the reputation of one related entity to the reputation of the other related entity.

### CROSS-REFERENCE TO RELATED APPLICATIONS

This application claims priority under 35 U.S.C. §119(e) to U.S. Provisional Application Ser. No. 61/334,799 titled “Identifying Mobile Device Reputations” filed May 14, 2010, the disclosure of which is incorporated herein by reference in its entirety.

### TECHNICAL FIELD

This disclosure relates generally to identifying mobile device reputation.

### BACKGROUND

Internet connectivity has become central to many daily activities. For example, millions of people in the United States use the internet for various bill pay and banking functionalities. Countless more people use the internet for shopping, entertainment, to obtain news, and for myriad other purposes. Moreover, many businesses relies on the internet for communicating with suppliers and customers, as well as providing a resource library for their employees.

However, mobile devices have recently begun contributing a large amount of data to the internet. For example, mobile communications devices, such as the Blackberry™ available from Research In Motion Limited of Waterloo in Ontario, Canada, or the Treo™ available from Palm, Inc. of Sunnyvale, Calif., are able to send and receive electronic messages from the internet. Moreover, cellular phones are able to send and receive text messages using a short message service, some of which originate or are destined for an Internet entity. However, these devices can be vulnerable to exploitation, for example, as zombie messaging devices or can compromise sensitive company data such as customer and contact lists.

### SUMMARY

Systems and methods used to identify mobile device reputations are disclosed. Example methods used to identify mobile device reputations can include: collecting a plurality of data packets associated with one or more traffic streams from a network, the one or more traffic streams comprising communications between a plurality of entities associated with the network including one or more mobile entities; correlating the data packets to identify a plurality of attributes associated with the plurality of entities coupled to the network, the plurality of entities comprising one or more mobile entities; analyzing the plurality of attributes to identify relationships among entities based upon the identified attributes exhibiting commonalities between the entities or associated traffic streams; and attributing at least a portion of a reputation from a known entity to at least an unknown mobile entity based upon identification of a relationship between the known entity and the unknown mobile entity

Example systems that can be used to identify mobile device reputations can include a data collection module, a correlation module, and an analysis module. The data collection module can receive a data transmitted across a network. The correlation module can parse the data to derive one or more attributes associated with network entities. The network entities can include a mobile entity associated with the data. The analysis module can identify relationships between entities based upon the derived attributes exhibited by the network entities or associated data. The analysis module can further attribute at least a portion of a reputation of a known entity from among the network entities to an unknown mobile entity based upon identification of a relationship between the known entity and the unknown mobile entity.

The details of one or more embodiments of the subject matter described in this specification are set forth in the accompanying drawings and the description below. Other features, aspects, and advantages of the subject matter will become apparent from the description, the drawings, and the claims.

### DESCRIPTION OF DRAWINGS

FIG. 1 is a block diagram of an example network environment including reputation modules for wireless entities.

FIG. 2 is a block diagram of an example network architecture including security systems using reputation to analyze data.

FIG. 3 is a block diagram illustrating the attachment of identifiers and attributes to entities and data.

FIG. 4 is a block diagram of an example of identifiers and attributes used to detect relationships between entities.

FIG. 5 is a block diagram of an example security system including correlation and analysis modules.

FIG. 6 is a block diagram illustrating an example network architecture of a distributed reputation module.

FIG. 7 is a block diagram illustrating a determination of a global reputation based on local reputation feedback.

FIG. 8 is a flowchart depicting an example method used to detect relationships and assign reputation to mobile entities.

### DETAILED DESCRIPTION

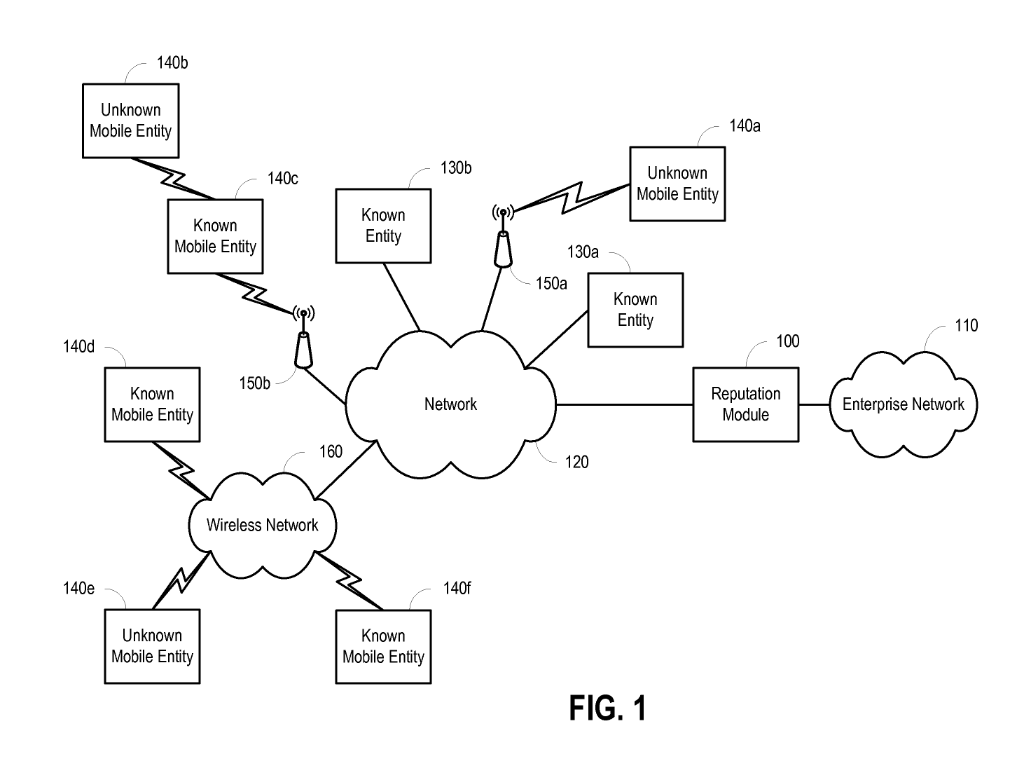

FIG. 1 is a block diagram of an example network environment including a reputation module 100 for wireless entities. In some implementations, a reputation module 100 can reside between a firewall system and servers internal to a network 110 (e.g., an enterprise network). In various examples, the network 110 can include a number of servers, including, for example, electronic mail servers, web servers, and various application servers as may be used by the enterprise associated with the network 110. In other implementations, the network can include gateways for communicating with mobile communications devices (e.g., IEEE 802.11x devices, evolution-data optimized (EV-DO) devices, bluetooth devices, and cellular devices, among others).

In various implementations, the reputation module 100 can monitor communications entering and exiting the network 110. These communications can be received, for example, through an external network 120 (e.g., the Internet) from any known entities 130a-b connected to the external network 120 or from any known or unknown mobile entities 140a-f connected to the external network 120 using an access point 150a-b or a wireless network 160. One or more of the entities 130a-b or mobile entities 140a-g can be legitimate originators of communications traffic while other(s) of the entities 130a-b or mobile entities 140a-g can also be non-reputable entities originating unwanted communications. In various examples, it can be difficult to know in advance which of the entities 130a-b or mobile entities 140a-g are originating unwanted communications and which are originating legitimate communications.

In various implementations, the reputation module can inspect data packets (e.g., individual data packets, groups of data packets, streams of data packets, data in transit, data residing on a server, etc.) to determine a reputation of an entity 130a-b or mobile entity 140a-f associated with the data packets. In some implementations, the reputation module 100 can determine what action to take with respect to data packets based upon the reputation of the originating entity 130a-b, 140a-f. For example, if the reputation module 100 determines that the originator of the communication is a reputable entity the reputation module 100 can forward the communication to the recipient of the communication. However, if the reputation module 100 determines that the originator of the communication is non-reputable, for example, the reputation module 100 can quarantine the communication, perform an action (e.g., perform more tests on the message, require authentication from the message originator, etc.) based upon the reputation determination.

There are a variety of techniques that can be used to implement a reputation module. Example reputation modules are described in detail in United States Patent Publication No. 2006/0015942, which is hereby incorporated by reference.

In further implementations, the reputation module 100 can monitor data and derive the reputable and non-reputable characteristics of the data by identifying the attributes and/or characteristics associated with the data. For example, the attributes and/or characteristics associated with data can be derived for comparison with the attributes of known reputable and known non-reputable data to determine whether the data is legitimate or not. Systems and methods used to profiling communications is described in detail in U.S. application Ser. No. 11/173,941, entitled “Message Profiling Systems and Methods,” filed on Jun. 2, 2005. In some implementations, when data is identified as non-legitimate, the reputation information associated with the sender and/or recipient can be adjusted to reflect the detection of the non-legitimate data.

In various examples, the reputation server can differentiate between known entities 130a-b, 140c, 140d, 140f, and unknown entities 140a, 140b, 140e. The known entities 130a-b, 140c, 140d, 140f are those entities that have previously been identified as reputable or non-reputable by the reputation module 100. The unknown entities 140a, 140b, 140e are those entities that have not previously been identified by the reputation module 100. In various implementations, the reputation module 100 can examine the identifiers and attributes associated with the unknown entities 140a, 140b, 140e in an attempt to identify commonalities with known entities 130a-b, 140c, 140d, 140f. In those instances when commonalities are identified, a portion of the reputation of the known entity or entities 130a-b, 140c, 140d, 140f can be attributed to the unknown entities 140a, 140b, 140e based upon the particular identifier or attribute that the unknown entities 140a, 140b, 140e has in common with the known entities 130a-b, 140c, 140d, 140f.

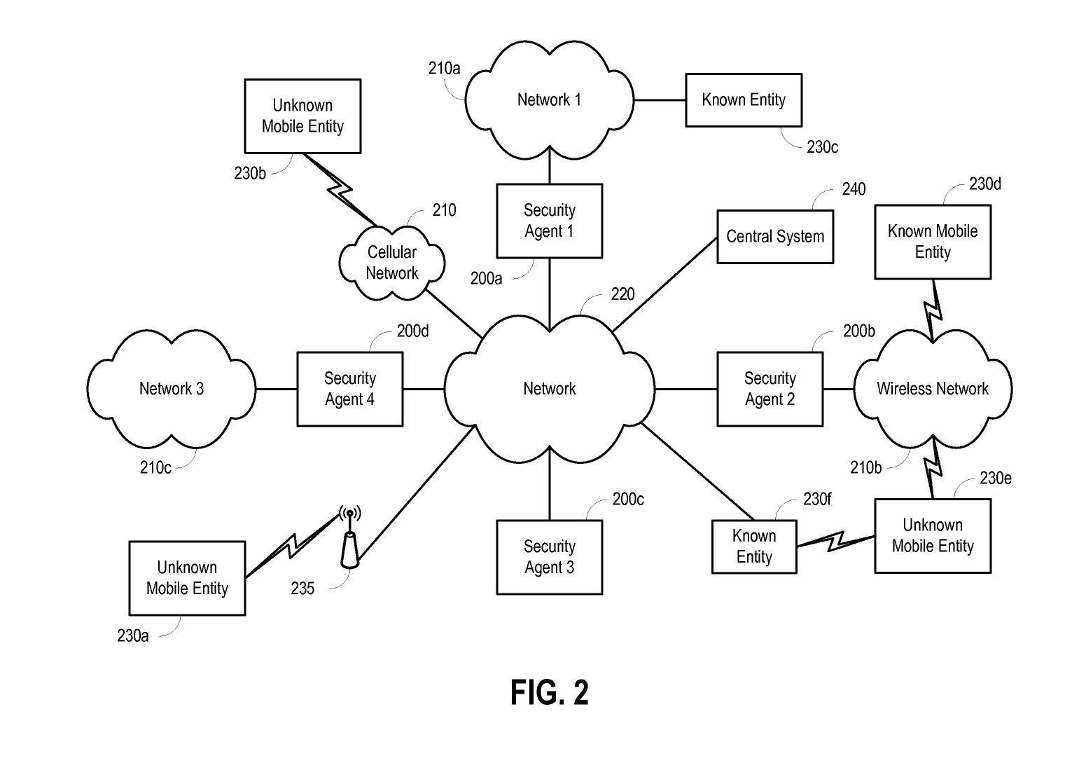

FIG. 2 is a block diagram of an example network architecture including security systems 200 using reputation to analyze data. Security systems 200a, 200b, 200d are shown logically residing between networks 210a-c, respectively, and the network 220. In some implementations, a security system 200c can be connected to the network 220 to collect data about the various communications traversing the network 220 (e.g., the internet). While not shown in FIG. 2, in various implementations a firewall device can be installed between the security systems 200a, 200b, 200d and the network 220 to provide protection against unauthorized communications entering the respective networks 210a-c. Moreover, intrusion detection systems (IDS) can be deployed in conjunction with firewall systems to identify suspicious patterns of activity and to signal alerts when such activity is identified.

While systems such as firewalls and IDSs provide some protection for a network, these systems often do not address application level security threats. For example, hackers often attempt to use various network-type applications (e.g., e-mail, web, instant messaging (IM), etc.) to create a pre-textual connection with the networks 210a-c in order to exploit security holes created by these various applications used on entities 230a-f.

However, not all entities 230a-f imply threats to the network 210a-c. For example, some of the entities 230a-f can originate legitimate traffic, allowing the employees of a company to communicate with business associates more efficiently. While examining the communications for potential threats is useful, it can be difficult to maintain current threat information because attacks are being continually modified to account for the latest filtering techniques. Thus, in some implementations, security systems 200a-c can run multiple tests on data to determine whether the communication is legitimate.

In various implementations, security systems 200a-d can include reputation modules that can assist in identifying the bulk of the malicious communications without extensive and potentially costly local analysis of the content of the communication. Reputation modules can also help to identify legitimate communications and prioritize their delivery and reduce the risk of misclassifying a legitimate communication. Moreover, reputation modules can provide a dynamic and predictive approaches to the problem of identifying malicious transactions, as well as legitimate transactions, in physical or virtual worlds. Examples include the process of filtering malicious communications in an email, instant messaging, VoIP, SMS or other communication protocol system using analysis of the reputation of sender and/or data. Security system 200 can then apply a global or local policy to determine what action to perform with respect to the communication (such as deny, quarantine, load balance, deliver with assigned priority, analyze locally with additional scrutiny) to the reputation result.

In such implementations including a reputation module/engine, sender and/or recipient information included in the communication can be used to help determine whether or not a communication is legitimate. For example, security systems 200a-d can track entities 230a-f and analyze the characteristics and attributes of the entities and/or data to help determine whether to allow a communication to enter a network 210a-c. The entities 230a-f can then be assigned a reputation based on the analysis of the characteristics and attributes of the entities 230a-f and/or the data associated with those entities 230a-f. In various implementations, decisions regarding transmission of data can take into account the reputation of an entity 230a-f that originated the communication, the reputation of an entity 230a-f receiving the communication or the reputation of the data itself. Moreover, in some implementations, one or more central systems 240 can collect information on entities 230a-f and distribute the collected data to other central systems 240 and/or the security systems 200a-d.

The entities 230a-f can connect to the internet in a variety of methods. In various examples the entities can include mobile entities 230a-b, 230d-e. Mobile entities 230a-b, 230d-e can be difficult to trace because such entities 230a-b, 230d-e are mobile and can access the network from a variety of locations. Moreover, mobile entities 230a-b, 230d-e can be difficult to track because non-reputable mobile entities often attempt to disguise their identity by spoofing other entity addresses. However, in some implementations, the actions of various entities 230a-f can be tracked and correlated to determine relationships between the entities 230a-f. For example, a mobile device could turn out to have several identities (e.g., entities) that it uses to access the network 220.

In various examples, an entity 230a-f can have multiple identifiers (such as, for example, e-mail addresses, IP addresses, identifier documentation, media access control (MAC) addresses, phone number, subscriber identity module (SIM) integrated circuit card ID (ICCID), international mobile subscriber identity (IMSI), etc.) at the same time or over a period of time. In one such example, a mail server with changing IP addresses might have multiple identities over time. In another example, a mobile devices 230a-b, 230d-e might have several different MAC addresses over time. Moreover, one identifier can be associated with multiple entities, such as, for example, in a mobile network when an service set identifier (SSID) address is shared by an organization with many users behind the IP address. The specific method used to connect to the internet can also obscure the identification of the entity 230a-f. For example, an unknown mobile entity 230b can connect to the network 120 using a cellular service provider network 210. In some examples, devices 230a-f can also disguise their identity by spoofing a legitimate entity. Thus collecting data on the characteristics of each entity 230a-f can help to categorize an entity 230a-f and determine how to handle a communication.

The ease of creation and spoofing of identities in both virtual and physical world can create an incentive for users to act maliciously without bearing the consequences of that act. For example, a stolen IP or MAC address on the Internet of a legitimate entity by a criminal can enable that criminal to participate in malicious activity with relative ease by assuming the stolen identity. However, by assigning a reputation to the physical and virtual entities and recognizing the multiple identities that they can employ, reputation systems can influence reputable and non-reputable entities to operate responsibly for fear of becoming non-reputable, and being unable to correspond or interact with other network entities.

In various implementations, the reputations of mobile entities 230a-b, 230d-e can be identified and tracked based on the traffic originating from and destined to the mobile entities 230a-b, 230d-e. For example, the communications originating from mobile entities 230a-b, 230d-e can be identified based on an address associated with the entity or another characteristic associating the mobile entities 230a-b, 230d-e to the communication. Such communications can be analyzed and correlated to identify relationships between the mobile entities 230a-b, 230d-e and other entities 230c, 230f or between other mobile entities 230a-b, 230d-e. In various implementations, volume characteristics, traffic patterns, communication with non-reputable entities, similar content, etc. can be used to identify relationships between mobile entities 230a-b, 230d-e and any of the other entities 230c, 230f. In some implementations, data and behavior associated with mobile entities 230a-b, 230d-e can be mapped and correlated to known data and behavior mappings of known entities 230c-d, 230f.

In additional implementations, security systems 200a-d can notify carriers associated with a mobile device (e.g., mobile device 230b) based upon a reputation associated with the mobile device 230b. The carrier network can use this information, for example, to correct pt limit the behavior exhibited by the mobile device 230b. In some implementations, if the security system determines that a mobile device 230b associated with a carrier network (e.g., cellular network 210) is non-reputable, the reputation associated with that mobile device can affect a reputation associated with the carrier network. Such implementations can provide incentive for a carrier to correct or limit the behavior and/or relationship affecting the reputation of the carrier network.

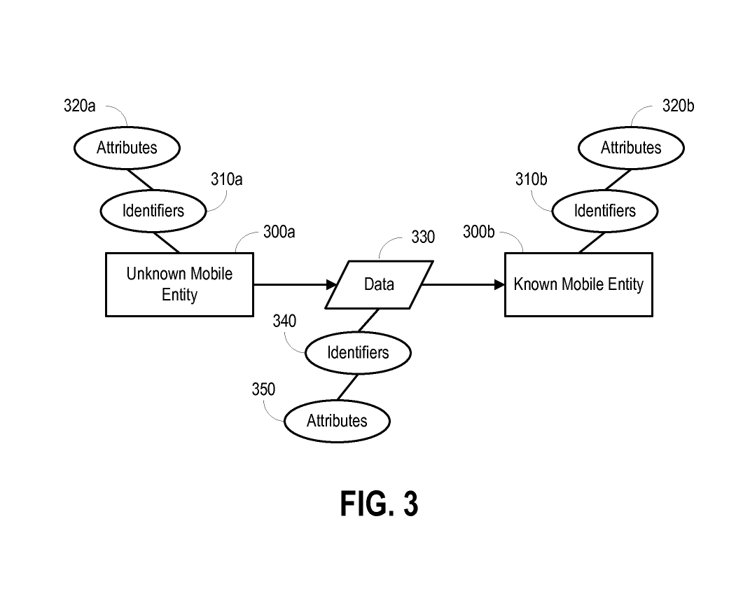

FIG. 3 is a block diagram illustrating the attachment of identifiers 310 and attributes 320 to entities 300 and data 330. In some implementations, known non-reputable entity 300a and the unknown mobile entity 300b can have a number of identifiers associated with the respective entities 300a-b. Identifiers can include categories of information that can be associated with an entity. For example, identifiers 310 can include IP addresses, universal resource locator (URL), MAC address, phone number, ICCID, IMSI, IM username(s), message content, domain, or any other label that might broadly describe a particular feature of an entity. In some implementations, mobile entities 300a-b can have a particular set of identifiers that can be used to identify the mobile entity. For example, mobile entities 300a-b can include identifiers such as SSID to identify a wireless local area network to which the entities 300a-b belong, MAC address, basic service set identifier (BSSID), extended service set identifier (ESSID). In some implementations, the mobile entity 300a-b can be a cellular phone or other mobile communications device (e.g., mobile e-mail device). Such mobile entities can include identifiers such as SIMs, ICCID, IMSI, etc.

In some implementations, a security system can identify data 330 originating from or destined to an unknown mobile entity 300a. The data 330 can include, for example, data packets (e.g., individual packets, streams of data packets, groups of data packets, etc.) being transmitted between an unknown mobile entity 300a and a known mobile entity 300b. In other examples, the data can include static data (e.g., data residing on a entity). In some implementations, static data can be identified by a security system on devices associated with the security system.

The data 330 can include several identifiers 340, including origination address, destination address, payload, and other overhead information that can be extracted from data packets. In some implementations, data 330 originating from an entity 300a can affect the reputation of an entity 300a based upon attributes associated with the identifiers. In other implementations, data 330 destined for an unknown mobile entity 300b can affect the reputation of the unknown mobile entity 300b based upon attributes associated with the identifiers. Moreover, the data 330 can be logged and correlated to identify similarities or commonalities between attributes associated with previously logged data.

In various implementations, the attributes can define the particular features of the entity associated with the identifier class. For example, an IP address identifier 310a associated with an unknown mobile entity 300a can include any IP addresses associated with that entity. Data 330 can include an identifier 340, such as, originating address and the attribute can be the address(es) (e.g., IP address, domain, MAC address, e-mail address, IM identification, etc.) associated with the entities originating the data 330.

Unknown entities 300a are those entities that have not been assigned a reputation. In some examples, unknown entities 300a might not yet be assigned a reputation because the entity 300a has not been previously observed by a security system. In other examples, unknown mobile entity 300b might not yet be assigned a reputation because the entity 300a reputation is indeterminate (e.g., exhibits multiple characteristics). Known entities 300b are those entities that have been assigned a reputation. In various implementations, reputations from known entities 300a, 300c can affect the reputation of both non-reputable entities (e.g., known non-reputable entity 300a) and other unknown entities (e.g., unknown mobile entity 300b). In some implementations, communication with many unknown entities (e.g., unknown mobile entity 300b) can affect the reputation of known reputable entities (e.g., known reputable entity 300c). For example, such an imputation of reputation can be based upon the implication that if a known reputable entity 300c is communicating with a higher than normal number of unknown entities (e.g., unknown mobile entity 300b) such communication can call the reputation of the reputation of the known reputable entity 300c into question until the unknown entities have been assigned a reputation.

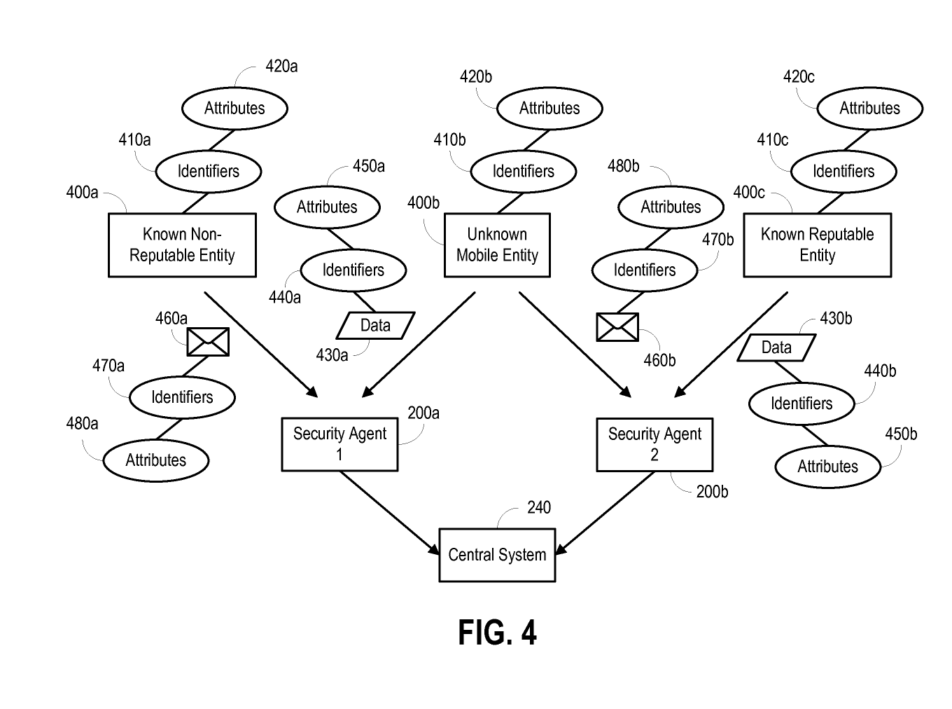

FIG. 4 is a block diagram of an example of identifiers and attributes used to detect relationships between entities. As shown in FIG. 4, in some implementations, each of the entities 400a-c is associated with one or more identifiers 410a-c, respectively. The identifiers 410a-c can include, for example, IP addresses, universal resource locator (URL), phone number, IM username, message content, domain, or any other identifier that might describe an entity. Moreover, the identifiers 410a-c are associated with one or more attributes 420a-c. As should be understood, the attributes 420a-c correspond to the particular identifier 410a-c that is being described. For example, a message content identifier could include attributes such as, for example, malware, volume, type of content, behavior, etc. Similarly, attributes 420a-c associated with an identifier, such as IP address, could include one or more IP addresses associated with an entity 400a-c.

In some implementations, security systems 200a-b can collect data by examining communications 460a-b or data directed to or otherwise associated with an associated network. In other implementations, security systems 200a-b can also collect data by examining communications that are relayed by an associated network. Examination and analysis of communications can allow the security systems 200a-b to collect information about the entities 400a-c sending and receiving messages, including transmission patterns, volume, or whether the entity has a tendency to send certain kinds of message (e.g., legitimate messages, spam, virus, bulk mail, etc.), among many others. In some implementations, the various attributes 420a-c, 450a-b, 480a-b associated with entities 400a-c can be examined to identify relationships between the entities 400a-c.

In further implementations, attribute information can be collected from data 430a-b or communications 460a-b (e.g., e-mail). Such data 430a-b or communications 460a-b can include some identifiers and attributes associated with the entity that originated the communication. For example, the communications 430a-c provide a transport for communicating information about the entity identifiers 410a-c to the security systems 200a, 200b. These identifiers 410a-c can be detected by the security systems 200a, 200b through examination of the header information included in the message, analysis of the content of the message, as well as through aggregation of information previously collected by the security systems 200a, 200b (e.g., totaling the volume of communications received from an entity).

The attribute data collected by multiple security systems 200a, 200b can be aggregated and mined. For example, the attribute data can be aggregated and mined by a central system 240 which receives identifiers and attribute information associated with all entities 400a-c for which the security systems 200a, 200b have received communications. Alternatively, the security systems 200a, 200b can operate as a distributed system, communicating identifier and attribute information about entities 400a-c with each other. The process of mining the data can correlate the attributes of entities 400a-c with each other, thereby identifying relationships between entities 400a-c (such as, for example, correlations between an event occurrence, volume, and/or other determining factors).

In various implementations, identified relationships can then be used to establish a multi-dimensional reputation “vector” for all identifiers based on the correlation of attributes that have been associated with each identifier. For example, if a non-reputable entity 400a with a known reputation for being non-reputable sends a communication 460a with a first set of attributes 480a, and then an unknown mobile entity 400b sends data 430a with a second set of attributes 450a, the security system 200a can determine whether all or a portion of the first set of attributes 480a matches all or a portion of the second set of attributes 450a. When some portion of the first set of attributes 480a matches some portion of the second set of attributes 450a, a relationship can be identified between the known non-reputation entity 400a and the unknown mobile entity 400b. In some implementations, the relationship between the entities can be defined based upon the particular entity identifier 410a, 410b that included the matching attributes 420a, 420b. The communication identifiers 470a, 440a which are found to have matching attributes can thereby be used to determine a strength associated with the relationship between the known non-reputable entity 400a and the unknown mobile entity 400b. In some implementations, the strength of the relationship can be used to determine which portion of the non-reputable qualities of the non-reputable entity 400a can be attributed to the reputation of the unknown mobile entity 400b.

However, it should also be recognized that the unknown mobile entity 400b may originate a communication 460b which includes attributes 480b that match some attributes 450b of a communication 430b originating from a known reputable entity 400c. The particular identifiers 470b, 440b which are found to have matching attributes can be used to determine a strength associated with the relationship between the unknown mobile entity 400b and the known reputable entity 400c. The strength of the relationship can be used to determine how much of the reputable qualities of known reputable entity 400c are attributed to the reputation of the unknown mobile entity 400b.

In some implementations, a distributed reputation module can also provide real-time collaborative sharing of global intelligence about the latest threat landscape, providing instant protection benefits to the local analysis that can be performed by a filtering or risk analysis system, as well as identify malicious sources of potential new threats before they even occur. Using sensors positioned at many different geographical locations, information about new threats can be quickly identified and shared with the central system 240, or with the distributed security systems 200a, 200b. Such distributed sensors can include the local security systems 200a, 200b, as well as local reputation clients, traffic monitors, or any other device (e.g., switches, routers, servers, etc.) suitable for collecting data (e.g., transient or static).

For example, security systems 200a, 200b can communicate with a central system 240 to provide sharing of threat and reputation information. Alternatively, the security systems 200a, 200b can communicate threat and reputation information between each other to provide up to date and accurate threat information. In the example of FIG. 3, the first security system 200a has information about the relationship between the unknown mobile entity 400b and the non-reputable entity 400a, while the second security system 200b has information about the relationship between the unknown mobile entity 400b and the reputable entity 400c. Without sharing the information, the first security system 200a may take a particular action on a communication originating from or destined to the unknown mobile entity 400b based upon the detected relationship to the known non-reputable entity 400a. However, with the knowledge of the relationship between the unknown mobile entity 400b and the reputable entity 400c, the first security system 200a might take a different action with a received communication from the unknown mobile entity 400b. In such implementations, sharing of the relationship information between security systems 200a-b, can provides for a more complete set of relationship information upon which a determination will be made.

In various implementations, the system can attempt to assign reputations (reflecting a general disposition and/or categorization) to physical entities, such as individuals or automated systems performing transactions. In the virtual world, entities 400a-c can represented by attributes 420a-c associated with identifiers 410a-c (ex. MAC address, domains, users, IPs, URLs, content). Such attributes 420a-c can be are tied to those entities in the specific transactions (such as sending a message or transferring money out of a bank account) that the entities are performing. Reputation characteristics can thereby be assigned to those identifiers based on their overall behavioral and historical patterns as well as their relationship to other identifiers, such as the relationship of IPs sending messages and URLs included in those messages. A “bad” reputation for a single identifier can cause the reputation of other related identifiers to worsen, if there is a strong correlation between the identifiers. For example, an IP that is sending URLs which have a bad reputation will worsen its own reputation because of the reputation of the URLs. Finally, the individual identifier reputations can be aggregated into a single reputation (risk score) for the entity that is associated with those identifiers

In various implementations, attributes can fall into a number of categories. For example, evidentiary attributes can represent physical, digital, or digitized physical data about an entity. This data can be attributed to a single known or unknown entity, or shared between multiple entities (forming entity relationships). Examples of evidentiary attributes relevant to messaging security include IP (internet protocol) address, known domain names, URLs, digital fingerprints or signatures used by the entity, TCP signatures, etc.

In additional implementations, behavioral attributes can represent human or machine-assigned observations about either an entity or an evidentiary attribute. Such attributes may include one, many, or all attributes from one or more behavioral profiles. For example, a behavioral attribute generically associated with a spammer may be a high volume of communications being sent from that entity.

In some implementations, a number of behavioral attributes for a particular type of behavior can be combined to derive a behavioral profile. A behavioral profile can contain a set of predefined behavioral attributes. The attributive properties assigned to these profiles include behavioral events relevant to defining the disposition of an entity matching the profile. Examples of behavioral profiles relevant to messaging security might include, “Spammer”, “Scammer”, and “Legitimate Sender,” among many others. Events and/or evidentiary attributes relevant to each profile can define the types of entities to which a reputation associated with the behavioral profile should be assigned. In other words, an entity with attributes that match a behavioral profile can be assigned the reputation associated with that behavioral profile. This may include a specific set of sending patterns, blacklist events, or specific attributes of the evidentiary data. Some examples include: sender/receiver identification; time interval and sending patterns; severity and disposition of payload; message construction; message quality; protocols and related signatures; communications medium

In various implementations, entities sharing some or all of the same evidentiary attributes can have an evidentiary relationship. Similarly, entities sharing behavioral attributes have a behavioral relationship. These relationships help form logical groups of related profiles, which can then be applied adaptively to enhance the profile or identify entities slightly more or less standard with the profiles assigned.

In various implementations, mobile devices can include unique identifiers based upon the nature of the mobile entity (e.g., cellular phone, wireless local area network (WLAN) device, Bluetooth device, mobile e-mail client, etc.). For example, some mobile entity (e.g., unknown mobile entity 400b) can connect to many different wireless networks over a period of time. Each of the wireless networks with which the mobile entity has been associated can be recorded as an attribute associated with, for example, an SSID identifier. In some examples, encryption patterns associated with mobile entities can be identified and logged. In other examples, when a mobile entity connects to an unencrypted wireless network, such activity can be logged as an attribute of the entity and associated with an identifier.

Such attributes can be collected and correlated to identify relationships between a first mobile entity and a second mobile entity. In other examples, the attributes can be collected and correlated to identify relationships between a mobile entity and a stationary entity (e.g., desktop computer, electronic mail server, web server, wired network, etc.). In various implementations, mobile entities (e.g., 400b) can also include an identifier indicating that the entity is a mobile entity. In some implementations, relationships can be identified by analyzing the data and identifying patterns and trends within the data. Reputations assigned to a device can be affected by the relationships identified by a security system 200a-b, or the central system 240. In additional implementations, reputations can be affected by identification of anomalies within the data.

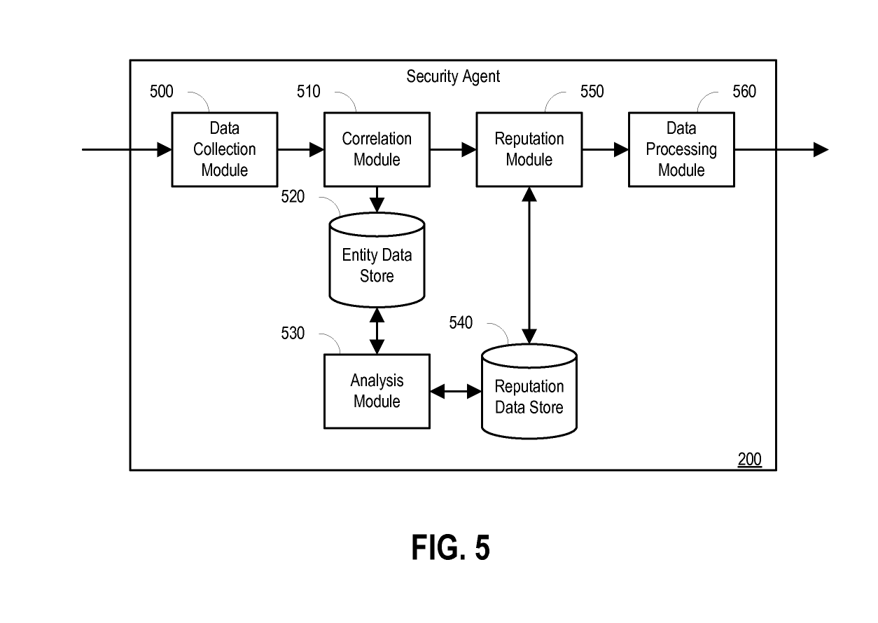

FIG. 5 is a block diagram of an example security system 200 including correlation and analysis modules. In some implementations, the security system 200 can include a data collection module 500. The data collection module 500 can include a communications interface configured to receive data from an entity.

The security system 200 can also include a correlation module 510. The correlation module 510 can receive the incoming data from the data collection module 500 and parse the data to derive attributes associated with the data. Such attributes can be categorized and stored under various identifiers associated with entities originating and/or receiving the data. For example, the data can include an origination address and a destination address. As such, the attributes identified by data can be linked to the entities associated with the data. The correlation module 510 can transmit the parsed data to an entity data store 520 for storage.

In some implementations, the entity data store 520 can store the data for subsequent analysis of the data to identify relationships (e.g., patterns, trends or anomalies) in the entity data. An analysis module 530 can be used to identify the relationships between entities. The relationships identified by the analysis module can be used to modify the relationship of a first entity based upon an identified relationship with a second entity. For example, “bots” (e.g., computers that have software installed (e.g., surreptitiously) that causes the computer to transmit data to other computers without knowledge of the computer user) often transmit data on a schedule. The analysis module 530 can identify the schedule associated with an entity that has a reputation for “bot” behavior, and then identify other entities that are transmitting data based on a similar schedule. Transmission of data on a similar schedule might indicate that the entities are related. Whether the relationship is important can be based upon the level of similarity found, as well as other factors that the entities may have in common.

In some implementations, reputation data can be obtained from a reputation data store 540. In various implementations, the reputation data store can comprise a local reputation data store or a global reputation data store. In some examples, local reputation data stores can be affected by the characteristics of the local network (e.g., tolerance for various classifications of traffic). A global reputation data store can provide a reputation based upon a common characterization of various attributes.

In the example provided above, the analysis module 530 can use the “bot” reputation of the known entity to transferred that reputation to other entities based upon the other entities exhibiting similar behavior to the known entity. Imputation of reputation from one entity to another can be based upon the probability that entities that associate with non-reputable entities are more likely to be non-reputable, and entities that associate with reputable entities are more likely to be reputable. The analysis module 530 can modify the reputations of entities identified by the reputation data store 540. In those instances where an entity does not appear in the reputation data store 540, the analysis module 530 can add the entity to the reputation data store 540.

In some implementations, a reputation module 550 can receive data from the correlation module 510. The reputation module 550 can parse the data to identify a sender (e.g., origination address) and/or recipient (e.g., destination address) of the data. Upon identifying the sender and/or recipient of the data, the reputation module can query the reputation data store for the reputation associated with the sender and/or recipient of the data.

The reputation module can then pass the data along with the reputation(s) of the sender and/or recipient of the data to a data processing module 560. In various implementations, the data processing module 560 can receive the reputation(s) of the sender and/or recipient of the data and determine what action to take with respect to the data. For example, in those instances when it is determined that the reputation(s) of the sender and/or recipient are reputable, the data processing module 560 can allow the data to be forwarded to the recipient. In those instances when it is determined that the reputation(s) of the sender and/or recipient are non-reputable (e.g., scammer, scammer, phisher, bot, etc.), the data processing module 560 can delay transmission of the data. In various implementations, delay of the transmission of the data can include, dropping the data, quarantining the data, etc.) In other implementations, if the sender and/or recipient are determined to be non-reputable, the data processing system can perform further tests on the data to determine if this particular data includes a policy and/or security violation.

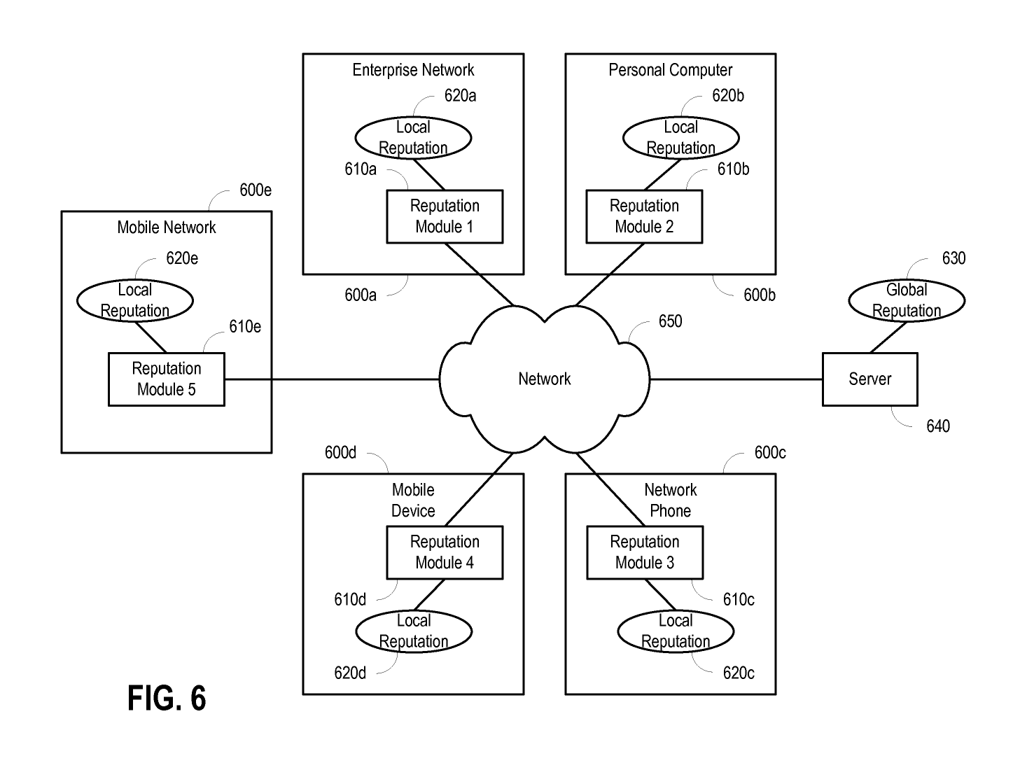

FIG. 6 is a block diagram illustrating an example network architecture of a distributed reputation module. The local entities 600a-e associated with the local reputation modules 610a-e can include local reputations 620a-e derived by local reputation modules 610a-e and a global reputation 630 stored by one or more servers 640. The local reputation modules 610a-e, for example, can be associated with local security systems such as security systems 200. Alternatively, the local reputation modules 610a-e can be associated, for example, with a local client 600a-e. Each of the reputation modules 610a-e includes a list of one or more entities for which the reputation modules 610a-e stores a derived reputation 600a-e.

In various implementations, the reputation modules 610a-e can be deployed at a variety of different entities 600a-e. In the example of FIG. 6, the entities include an enterprise network 600a, a personal computer 600b, a network phone 600c, a mobile device 600d, and a mobile network 600e. Each of the entities 600a-e can include a reputation associated with the respective entities 600a-e. The entities 600a-e can receive communications from each other through a network 650. In various implementations, a security system at the client device can inspect data entering or leaving the entity. The security system can analyze the data to identify relationships between entities as well as to determine whether to allow the data to enter or leave the entity. The determination of whether to allow the data to enter of leave the system can be made, at least in part, based upon the reputation information associated with the entity originating or receiving the data as identified by the local reputations 620a-e housed at each of the reputation modules 610a-e.

These stored reputations 620a-e can be inconsistent between reputation modules, because each of the reputation modules 610a-e might observe different types of traffic. For example, reputation module 1 610a may include a reputation that indicates a particular mobile entity is reputable, while reputation module 2 610b may include a reputation that indicates that the same mobile entity is non-reputable. These local reputation inconsistencies can be based upon different traffic received from the entity. Alternatively, the inconsistencies can be based upon the feedback from a user of local reputation module 1 610a indicating a communication is legitimate, while a user of local reputation module 2 610b provides feedback indicating that the same communication is not legitimate.

In various implementations, the server 640 can receives reputation information from the local reputation modules 610a-e. However, as noted above, some of the local reputation information may be inconsistent with other local reputation information. The server 640 can arbitrate between the local reputations 620a-e to determine a global reputation 630 based upon the local reputation information 620a-e. In some examples, the global reputation information 630 can then be provided back to the local reputation modules 610a-e to provide these local reputation modules 610a-e with up-to-date reputation information. Alternative, the local reputation modules 610a-e can be operable to query the server 640 for reputation information. In some examples, the server 640 responds to the query with global reputation information 630.

In some implementations, the server 640 can apply a local reputation bias to the global reputation 630. The local reputation bias can be applied to perform a transform on the global reputation 630 to provide the local reputation modules 610a-e with a global reputation vector that is biased based upon the preferences of the particular local reputation module 610a-e which originated the query. Thus, a local reputation module 610a with an administrator or user(s) that has indicated a high tolerance for spam messages can receive a global reputation vector that accounts for an indicated tolerance. The particular components of the reputation vector returns to the reputation module 610a might include portions of the reputation vector that are deemphasized with relationship to the rest of the reputation vector. Likewise, a local reputation module 610b that has indicated, for example, a low tolerance communications from entities with reputations for originating viruses may receive a reputation vector that amplifies the components of the reputation vector that relate to virus reputation.

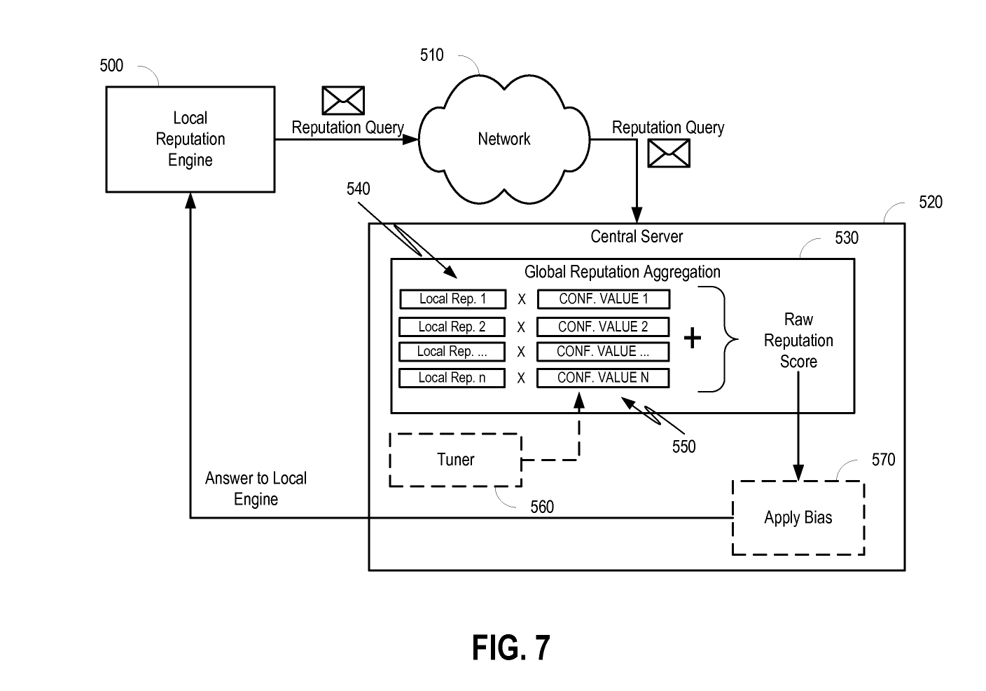

FIG. 7 is a block diagram illustrating a determination of a global reputation based on local reputation feedback. A local reputation module 700 is operable to send a query through a network 710 to a server 720. In some examples, the local reputation module 700 originates a query in response to receiving a communication from an unknown entity (e.g., an unknown mobile entity). Alternatively, the local reputation module 700 can originate the query responsive to receiving any communications, thereby promoting use of more up-to-date reputation information.

The server 720 is operable to respond to the query with a global reputation determination. The central server 720 can derive the global reputation using a global reputation aggregation module 730. The global reputation aggregation module 730 is operable to receive a plurality of local reputations 740 from a respective plurality of local reputation modules. In some examples, the plurality of local reputations 740 can be periodically sent by the reputation modules to the server 720. Alternatively, the plurality of local reputations 740 can be retrieved by the server upon receiving a query from one of the local reputation modules 700.

The local reputations can be combined using confidence values related to each of the local reputation modules and then accumulating the results. The confidence value can indicate the confidence associated with a local reputation produced by an associated reputation module. Reputation modules associated with small networks or small amounts of traffic, for example, can receive a lower weighting in the global reputation determination. In contrast, local reputations associated with reputation modules operating on large networks can receive greater weight in the global reputation determination based upon the confidence value associated with that reputation module.

In some examples, the confidence values 750 can be based upon feedback received from users. For example, a reputation module that receives feedback indicating that communications were not properly handled because local reputation information 740 associated with the communication indicated the wrong action can be assigned low confidence values for local reputations 740 associated with those reputation modules. Similarly, reputation modules that receive feedback indicating that the communications were handled correctly based upon local reputation information 740 associated with the communication indicated the correct action can be assigned a high confidence value 750 for local reputations 740 associated with the reputation module. Adjustment of the confidence values associated with the various reputation modules can be accomplished using a tuner 760, which is operable to receive input information and to adjust the confidence values based upon the received input. In some examples, the confidence values 750 can be provided to the server 720 by the reputation module itself based upon stored statistics for incorrectly classified entities. In other examples, information used to weight the local reputation information can be communicated to the server 720.

In some examples, a bias 770 can be applied to the resulting global reputation vector. The bias 770 can normalize the reputation vector to provide a normalized global reputation vector to a reputation module 700. Alternatively, the bias 770 can be applied to account for local preferences associated with the reputation module 700 originating the reputation query. Thus, a reputation module 700 can receive a global reputation vector matching the defined preferences of the querying reputation module 700. The reputation module 700 can take an action on the communication based upon the global reputation vector received from the server 720.

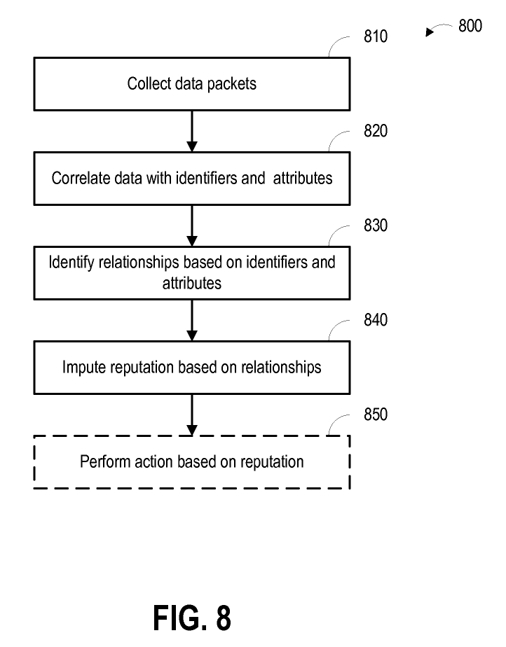

FIG. 8 is a flowchart depicting an example method 800 used to detect relationships and assign reputations to mobile entities. Data packets are collected at stage 810. Data packets can be collected, for example, by a collection module (e.g., collection module 500 of FIG. 5), as well as by a client device, a switch, a router, or any other device operable to receive communications from network entities (e.g., e-mail servers, web servers, IM servers, ISPs, file transfer protocol (FTP) servers, gopher servers, VoIP equipments, mobile entities, etc.).

Identifiers and attributes can be correlated with the collected data (e.g., communication data) at stage 820. Identifiers and attributes can be correlated with the collected data, for example, by a correlation module (e.g., correlation module 510 of FIG. 5). In some implementations, the correlation of data to identifiers and attributes can be performed by a central system (e.g., central system 240 of FIG. 2) operable to aggregate data from a number of sensor devices, including, for example, one or more security systems (e.g., security systems 200 of FIG. 2). In other implementations, correlation of data to identifier and attributed, for example, can be performed by the security systems.

In various implementations, the identifiers can be based upon the type of communication received. For example, an e-mail can include one set of information (e.g., IP address of originator and destination, text content, attachment, etc.), while a VoIP communication can include a different set of information (e.g., originating phone number (or IP address if originating from a VoIP client), receiving phone number (or IP address if destined for a VoIP phone), voice content, etc.). Similarly, mobile devices can include a set of identifiers associated with mobile entities (SSID, carrier network, MAC address, etc.).

Attributes associated with the entities can be analyzed at stage 830. Analysis of attributes associated with the entities can be performed, for example, by a central system 240. In other implementations, analysis of attributes associated with the entities including the mobile entity can be performed, for example, by one or more distributed security systems 200 having an analysis module (e.g., analysis module 530 of FIG. 5). In some implementations, analysis of the attributes associated with the entities can be used to determine whether any relationships exist between a mobile entity and other entities for which communications information has been collected. In further implementations, the analysis can include comparing attributes related to one mobile entity to find relationships between the mobile entity and other entities. In yet further implementations, a strength can be associated with an identified relationship based upon the particular attribute which serves as the basis for the relationship.

Reputation can be imputed between entities at stage 840. The reputation can be imputed, for example, by an analysis module (e.g., analysis module 530 of FIG. 5) in conjunction with a reputation data store (e.g., reputation data store 540 of FIG. 5). In various implementations, the reputation assigned to a mobile entity can be based upon the relationship found between the mobile entity and one or more of the other entities and on the basis of the identifier which formed the basis for the relationship. In further implementations, the reputation assigned to a mobile entity can be based upon the strength of a relationship found between the mobile entity and another entity.

An action can be performed based upon the reputation at optional stage 850. The action can be performed, for example, by a security system (e.g., security system 200 of FIG. 2) having an output module (e.g., data processing module 560 of FIG. 5). In various implementations, the action can be performed on received data associated with an entity for which a reputation has been assigned. In further implementations, the action can include any of allow, deny, quarantine, load balance, deliver with assigned priority, or analyze locally with additional scrutiny, among many others.

In some implementations, mobile device applications that are downloaded to mobile devices may have reputations associated with them. For example, the reputation data store 540 may include reputation data for various mobile device applications. Data generated by the mobile device application and sent from a mobile device can be used to identify the mobile device executing the mobile device application. Accordingly, another device that receives the data will be attributed at least a portion of a reputation from the known mobile device application based upon identification of a relationship between the sending mobile device entity and the receiving mobile device entity.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be computer readable medium, such as a machine-readable storage device, a machine-readable storage substrate, a memory device, or a combination of one or more of them.

The terms “computer” or “server” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or one that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A method comprising:
collecting a plurality of data packets associated with one or more traffic streams from a network, the one or more traffic streams comprising communications between a plurality of entities associated with the network including one or more mobile entities;
correlating the data packets to identify a plurality of attributes associated with the plurality of entities coupled to the network, the plurality of entities comprising one or more mobile entities;
analyzing the plurality of attributes to identify relationships among entities based upon the identified attributes exhibiting commonalities between the entities or associated traffic streams; and
attributing at least a portion of a reputation from a known entity to at least an unknown mobile entity based upon identification of a relationship between the known entity and the unknown mobile entity.

2. The method of claim 1, wherein the identified attributes comprise evidentiary attributes and the method further comprises comparing the evidentiary attributes to one or more behavioral attributes, the behavioral attributes being characteristics associated with a known type of activity or entity.

3. The method of claim 1, wherein the relationship between the known entity and the unknown mobile entity is a network relationship.

4. The method of claim 1, wherein the attributes identifying a relationship between the known entity and the unknown mobile entity comprises one or more communications.

5. The method of claim 4, wherein the one or more communications comprise addresses including the known entity and the unknown mobile entity.

6. The method of claim 4, wherein the one or more communications comprise substantially similar communications associated with each of the known entity and the unknown mobile entity.

7. The method of claim 1, wherein the unknown mobile entity is a mobile communications device.

8. The method of claim 1, wherein attributes comprise behaviors exhibited by the entities.

9. The method of claim 1, further comprising determining whether to block a particular stream of the one or more traffic streams based upon the attributed reputation associated with one of the plurality of entities related to the particular stream.

10. The method of claim 1, further comprising:
detecting a high volume of data packets directed to a particular address; and
identifying patterns in the high volume of data packets;
correlating the patterns to known malicious patterns; and
attributing a reputation to the particular address based upon the correlation.

11. The method of claim 1, further comprising distributing attributed reputations to a plurality of reputation servers, each of the reputation servers being operable to route data packets based upon reputation information associated with a sender or a recipient.

12. The method of claim 1, wherein a set of attributes is common to a type of entity having already been defined with a reputation, and wherein that reputation can be attributed to the reputation of the unknown mobile entity.

13. The method of claim 1, further comprising the step of determining the portion of the reputation of the known entity which is to be attributed to the unknown mobile entity based upon the identified relationship.

14. A reputation system, the system comprising:
a data collection module operable to receive a plurality of data packets comprising data streams being transmitted across a network;
a correlation module operable to parse the plurality of data packets and to derive one or more attributes associated with a plurality of network entities, the plurality of network entities comprising at least one mobile entity associated with the data packets;
an analysis module operable to identify relationships between entities based upon the derived attributes exhibited by the plurality of entities or associated data packets; and
wherein the analysis module is further operable to attribute at least a portion of a reputation of a known entity from among the plurality of entities to an unknown mobile entity based upon identification of a relationship between the known entity and the unknown mobile entity.

15. The system of claim 14, wherein the identified attributes comprise evidentiary attributes and the correlation module is further operable to compare the evidentiary attributes to one or more behavioral attributes, the behavioral attributes being characteristics associated with a known type of activity or entity.

16. The system of claim 14, wherein the relationship between the known entity and the unknown mobile entity is a network relationship.

17. The system of claim 14, wherein the attributes associated with a relationship between the known entity and the unknown mobile entity comprises one or more communications.

18. The system of claim 17, wherein the one or more communications comprise addresses including the known entity and the unknown mobile entity.

19. The system of claim 17, wherein the one or more communications comprise substantially similar communications associated with each of the known entity and the unknown mobile entity.

20. The system of claim 14, a filtering module operable to block a particular stream from among the traffic streams based upon the attributed reputation associated with one of the plurality of entities related to the particular stream.

21. The system of claim 14, further comprising:
a detection module operable to detect a high volume of data packets directed to a particular address; and
a pattern identification module operable to identify patterns in the high volume of data packets;
wherein the correlation module is further operable to correlate the patterns to known malicious patterns; and
wherein the reputation module is operable to attribute a reputation to the particular address based upon the correlation.

22. The system of claim 14, further wherein the analysis module is further operable to distribute attributed reputations to a plurality of reputation servers, each of the reputation servers being operable to route data packets based upon reputation information associated with a sender or a recipient.

23. The system of claim 14, wherein a set of attributes is common to a type of entity having already been defined with a reputation, and wherein that reputation can be attributed to the reputation of the unknown mobile entity

24. The system of claim 14, wherein the reputation module is operable to determine which portion of the reputation of the known entity is to be attributed to the unknown mobile entity based upon the identified relationship.

25. The system of claim 14, wherein the data packets are generated in response to an execution of a mobile device application having a respective reputation, and attributing at least a portion of a reputation of a known entity from among the plurality of entities to an unknown mobile entity based upon identification of a relationship between the known entity and the unknown mobile entity comprises attributing a portion of the respective reputation of the mobile device application to the unknown mobile entity.

26. One or more computer readable media having software program code operable to identify relationships among network entities, comprising:
receiving a plurality of data packets, the plurality of data packets comprising one or more traffic streams communicating information on a network;
analyzing the plurality of data packets to identify one or more attributes of a plurality of entities associated with the data packets, the plurality of entities comprising at least one mobile entity;
identifying a relationship between a known entity and the at least one mobile entity based upon the identified attributes exhibited by the entities or an associated traffic stream; and
attributing at least a portion of a reputation from a known entity to an unknown mobile entity based upon identification of a relationship between the known entity and the unknown mobile entity.
